(19) United States
(12) Patent Application Publication
(10) Pub. No.: US 2026/0299869 A1
(43) Pub. Date: Oct. 1, 2026

(54) AUDIO OUTPUT CONFIGURATION ADJUSTMENT

(71) Applicant: Lenovo Global Technology (United States) Inc., Morrisville, NC (US)

(72) Inventors: John C. Mese, Cary, NC (US); Nathan Peterson, Oxford, NC (US); Mark Delaney, Raleigh, NC (US); Rafael Marius Radkowski, Apex, NC (US); John W. Nicholson, Cary, NC (US)

(21) Appl. No.: 19/094,190

(22) Filed: Mar. 28, 2025

(51) Int. Cl. G06F 3/16

(52) U.S. Cl. CPC G06F 3/162; G06F 3/165

(57) ABSTRACT

One embodiment provides a method, the method including: detecting, using an audio configuration system, a connection of a device having audio capabilities to a computing system; determining, using the audio configuration system and responsive to the detecting, whether at least one of: an audio output and an audio input of the computing system should utilize the audio capabilities of the device; and selecting, based upon the determining, an audio device for at least one of: the audio output and the audio input. Other aspects are claimed and described.

### BACKGROUND

Many users utilize portable devices to be used at different locations. For example, tablets, laptop computers, smart phones, and/or the like, may be utilized by users due to the convenience that is afforded to the user due to the portability of the device. Depending on the location where the user is utilizing the device, other devices may be connected to these portable devices. For example, if a user utilizes the device at home, the user may connect external components or devices, such as external speakers, external displays, external input devices (e.g., touch screens, keyboards, mice, etc.), external audio input device, peripheral devices (e.g., printers, scanners, data storage devices, etc.), and/or the like. Similar external components or devices may be available to a user at other locations where the user might utilize the devices, for example, at work, at a remote work location, at a conference room, and/or the like. Additionally, the portability of the devices allow a user to take the device to different locations within a building. For example, at work a user may utilize the device at a workspace, within a conference room, at a different workspace at a different time or day, and/or the like.

### BRIEF SUMMARY

In summary, one aspect provides a method, the method including: detecting, using an audio configuration system, a connection of a device having audio capabilities to a computing system; determining, using the audio configuration system and responsive to the detecting, whether at least one of: an audio output and an audio input of the computing system should utilize the audio capabilities of the device; and selecting, based upon the determining, an audio device for at least one of: the audio output and the audio input.

Another aspect provides a system, the system including: a processor; a memory device that stores instructions that, when executed by the processor, causes the system to: detect, using an audio configuration system, a connection of a device having audio capabilities to a computing system; determine, using the audio configuration system and responsive to the detecting, whether at least one of: an audio output and an audio input of the computing system should utilize the audio capabilities of the device; and select, based upon the determining, an audio device for at least one of: the audio output and the audio input.

A further aspect provides a product, the product including: a computer-readable storage device that stores executable code that, when executed by a processor, causes the product to: detect, using an audio configuration system, a connection of a device having audio capabilities to a computing system; determine, using the audio configuration system and responsive to the detecting, whether at least one of: an audio output and an audio input of the computing system should utilize the audio capabilities of the device; and select, based upon the determining, an audio device for at least one of: the audio output and the audio input.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method for selecting an audio output device to use for audio output of a computing system based upon determining whether the audio capabilities of a device should be utilized.

### DETAILED DESCRIPTION

Each of the different locations where a user may utilize a device may provide for different types of connectable components or devices, even if the devices may be of the same type. For example, a user may utilize a device at home and at work, with each location providing an external display device to which the user device can be connected. Each of these connectable components or devices may provide different capabilities. For example, some display devices may also have integral components, such as image capture devices, audio output devices, audio input devices, and/or the like. Thus, using the example of work and home, the display device at home may have an integral audio output device and the display device at work may not have an integral audio output device. Additionally, some locations may have multiple devices of the same device type or may have multiple devices that have some of the same capabilities. For example, one location may allow for the connection of multiple external display devices. As another example, a location may have a dedicated external audio output device and a display device with an audio output device.

When connecting the different external devices to a device, the computing system of the device may make adjustments to settings of the device depending on the different capabilities of the external devices. For example, when a user connects an external display device to a device having an integral display, the computing system of the device may making adjustments so that the visual output is output to the external display device. This may include displaying the visual output solely on the external display device or in addition to displaying the visual output on the integral display. How the visual output is displayed may be based upon historical settings that the user has provided for in previous sessions with the same device.

With audio output devices, the computing system may make adjustments whenever a device having audio capabilities is connected to the computing system. Generally, the computing system assumes the user wants to use the new device as the audio output device and then switches the audio output of the computing system to the new device. However, this may not always be what the user wants and may not always be useful to the user. For example, a user may connect the computing system to a display having audio output capabilities, but that does not have any speakers connected. In this case, the audio output would be being output to the display, but no sound would be heard due to the lack of speakers. As another example, a user may be utilizing headphones with a device and connect the device to an external speaker. The connection may result in the switch of the audio output from the headphones to the speaker, which may be undesired by the user.

Currently, if the audio output is switched to a device that the user does not want, the user has to select the audio output icon and manually select the desired audio output device. However, often the names of the audio output devices are based upon a manufacturer or model of the audio output device. The user may not know which one corresponds to the desired audio output device. Additionally, requiring the user to manually adjust the audio output can be disruptive to other people who may be in the vicinity of the computing system due to sound being output through the space, may be disruptive to meetings or other conferences that the user may be connected to due to the fact that the audio output device is not outputting sound for the user to hear, and/or the like. Thus, the manual techniques are cumbersome and frustrating, particularly for users who may not be using the same external components or same workspaces all the time.

Accordingly, the described system and method provides a technique for selecting an audio output device to use for audio output of a computing system based upon determining whether the audio capabilities of a device should be utilized. The audio configuration system detects a connection of a device having audio capabilities to a computing system. It should be noted that the connecting of the device may include the device being stationary and the computing system being connected to the device, for example, a laptop being connected to a docking station at a workspace, or may include the computing system being stationary and the device being connected to the computing system, for example, headphones being plugged into the headphone jack of the computing system. In other words, the detection of a connection does not designate which of the device or computing system is the one being moved.

Responsive to detecting the connection, the audio configuration system determines whether the audio output of the computing system should utilize the audio capabilities of the device. In other words, the system determines if audio being produced by the computing system should be output from the audio output component of the newly connected device. One technique for making this determination is to output a test tone through the audio output component of the newly connected device. Then, the system may determine if the test tone can be detected or is audible to a microphone or other audio input device of or connected to the computing system. This allows the system to determine if the audio output device of the newly connected device can produce an audible sound. Another technique for making this determination is to provide a notification to a user indicating that multiple audio output devices are available and requesting the user to indicate whether the audio output should be switched to a new device. Upon making this determination, the audio configuration system selects an audio output device for the audio output. The selected audio output device may be the new device or may be a device that was previously being utilized for audio output.

Therefore, a system provides a technical improvement over traditional methods for selecting audio output devices. The described system provides a technical improvement to the audio configuration technological field. The described system provides a technique for identifying which audio output device should be utilized when a device having audio capabilities is connected to a computing system, which provides for an automatic correction of a necessarily computer problem. The computer problem is that audio can be output to different audio output devices and that computing systems automatically change the audio output device to any newly connected audio output device. However, even if a device has audio capabilities, the device may not actually be usable for outputting audio, thereby creating an issue with the output of audio from a computing system. The described system is able to determine whether the audio output should be transferred to the new device, and thereafter select the correct audio output device for the audio output, which solves the computer problem, and, particularly solves the computer problem automatically.

The illustrated example embodiments will be best understood by reference to the figures. The following description is intended only by way of example, and simply illustrates certain example embodiments.

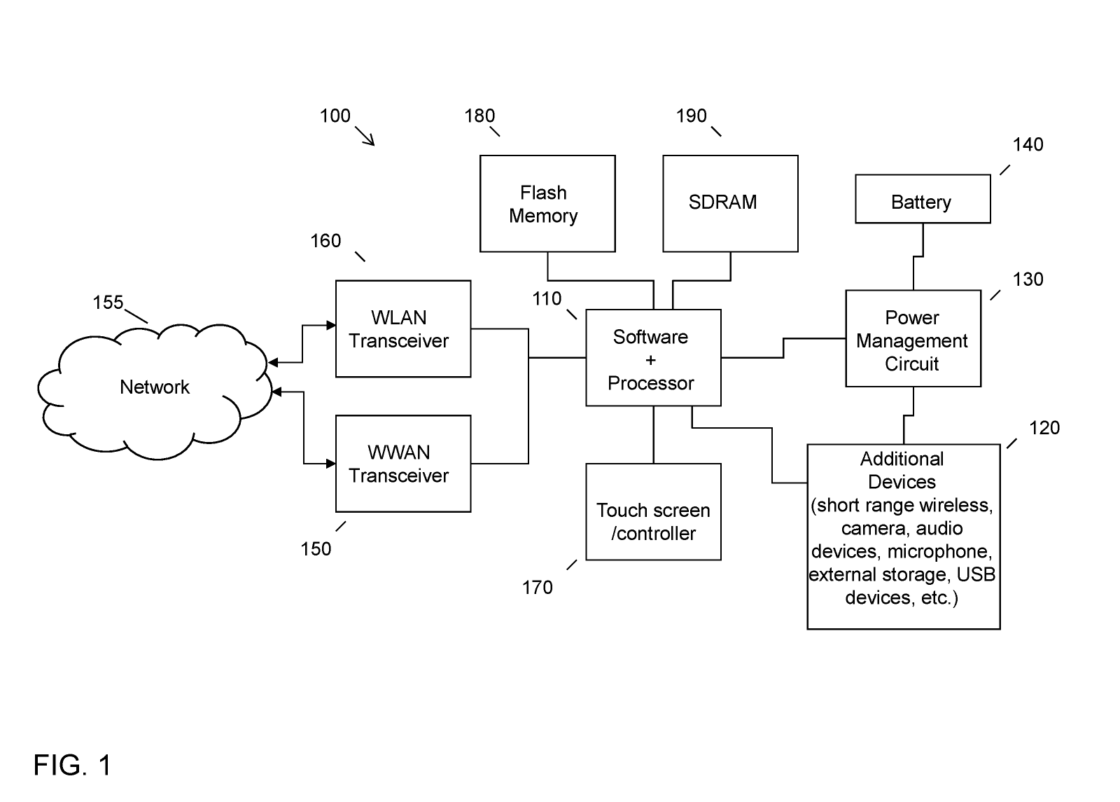

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, input/output (I/O) ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use serial advanced technology attachment (SATA) or peripheral component interconnect (PCI) or low pin count (LPC). Common interfaces, for example, include secure digital input/output (SDIO) and inter-integrated circuit (I2C).

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply basic input/output system (BIOS) like functionality and dynamic random-access memory (DRAM) memory.

System 100 typically includes one or more of a wireless wide area network (WWAN) transceiver 150 and a wireless local area network (WLAN) transceiver 160 for connecting to various networks 155 (e.g., telecommunications networks, wireless Internet devices (e.g., access points), cloud networks, remote networks, local networks, etc.). Additionally, devices 120 are commonly included, e.g., a wireless communication device, external storage, camera, microphone, external storage, etc. System 100 often includes a touch screen 170 for data input and display/rendering. System 100 also typically includes various memory devices, for example flash memory 180 and synchronous dynamic random-access memory (SDRAM) 190.

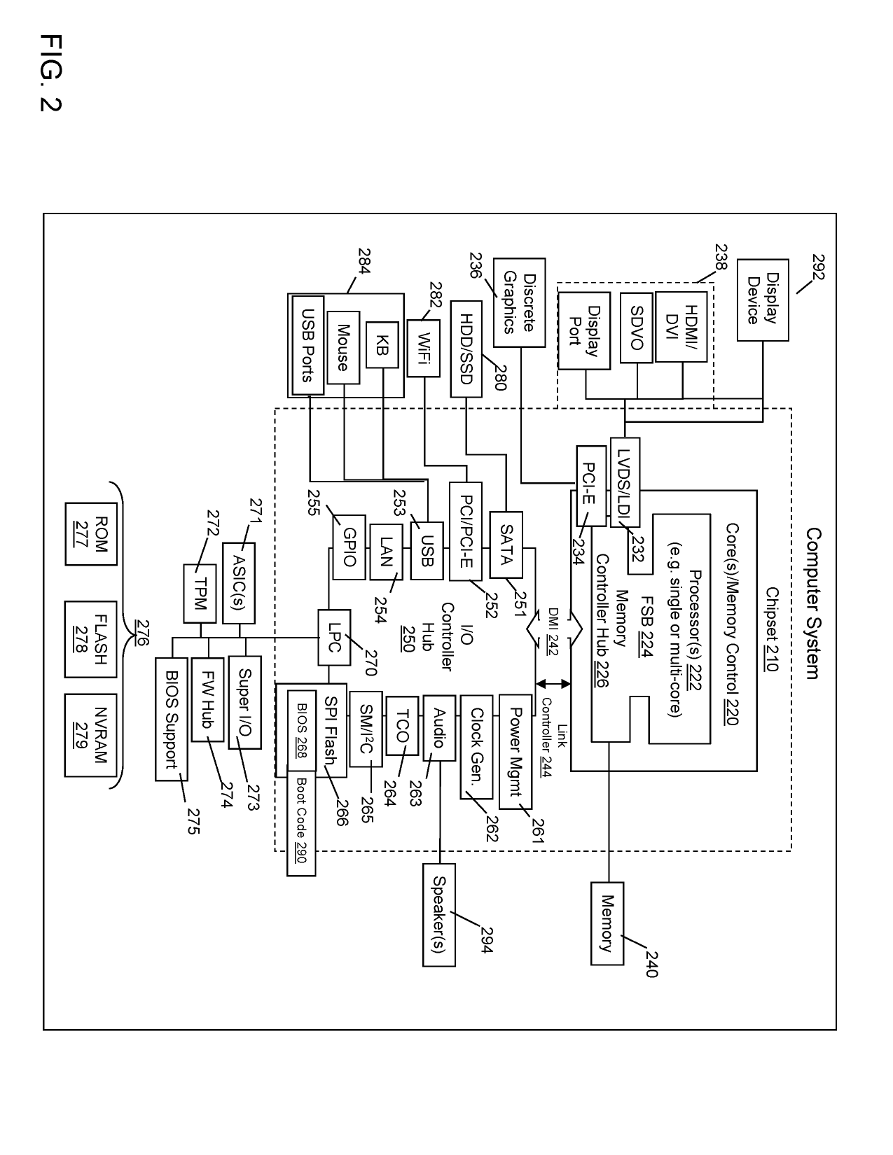

FIG. 2 depicts a block diagram of another example of information handling device circuits, circuitry, or components. The example depicted in FIG. 2 may correspond to computing systems such as personal computers, or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of random-access memory (RAM) that may be referred to as “system memory” or “memory”). The memory controller hub 226 further includes a low voltage differential signaling (LVDS) interface 232 for a display device 292 (for example, a cathode-ray tube (CRT), a flat panel, touch screen, etc.). A block 238 includes some technologies that may be supported via the low-voltage differential signaling (LVDS) interface 232 (for example, serial digital video, high-definition multimedia interface/digital visual interface (HDMI/DVI), display port). The memory controller hub 226 also includes a PCI-express interface (PCI-E) 234 that may support discrete graphics 236.

In FIG. 2, the I/O hub controller 250 includes a SATA interface 251 (for example, for hard-disc drives (HDDs), solid-state drives (SSDs), etc., 280), a PCI-E interface 252 (for example, for wireless connections 282), a universal serial bus (USB) interface 253 (for example, for devices 284 such as a digitizer, keyboard, mice, cameras, phones, microphones, storage, displays, speakers, microphones, other connected devices, etc.), a network interface 254 (for example, local area network (LAN)), a general purpose I/O (GPIO) interface 255, a LPC interface 270 (for application-specific integrated circuit (ASICs) 271, a trusted platform module (TPM) 272, a super I/O 273, a firmware hub 274, BIOS support 275 as well as various types of memory 276 such as read-only memory (ROM) 277, Flash 278, and non-volatile RAM (NVRAM) 279), a power management interface 261, a clock generator interface 262, an audio interface 263 (for example, for speakers 294), a time controlled operations (TCO) interface 264, a system management bus interface 265, and serial peripheral interface (SPI) Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIGS. 1 or 2, may be used in devices such as tablets, smart phones, personal computer devices generally, and/or electronic devices, which may be devices that are used to provide audio output, that are used by users to connect to audio output devices, that house or provide access to the audio configuration system, and/or the like. For example, the circuitry outlined in FIG. 1 may be implemented in a tablet or smart phone embodiment, whereas the circuitry outlined in FIG. 2 may be implemented in a personal computer embodiment.

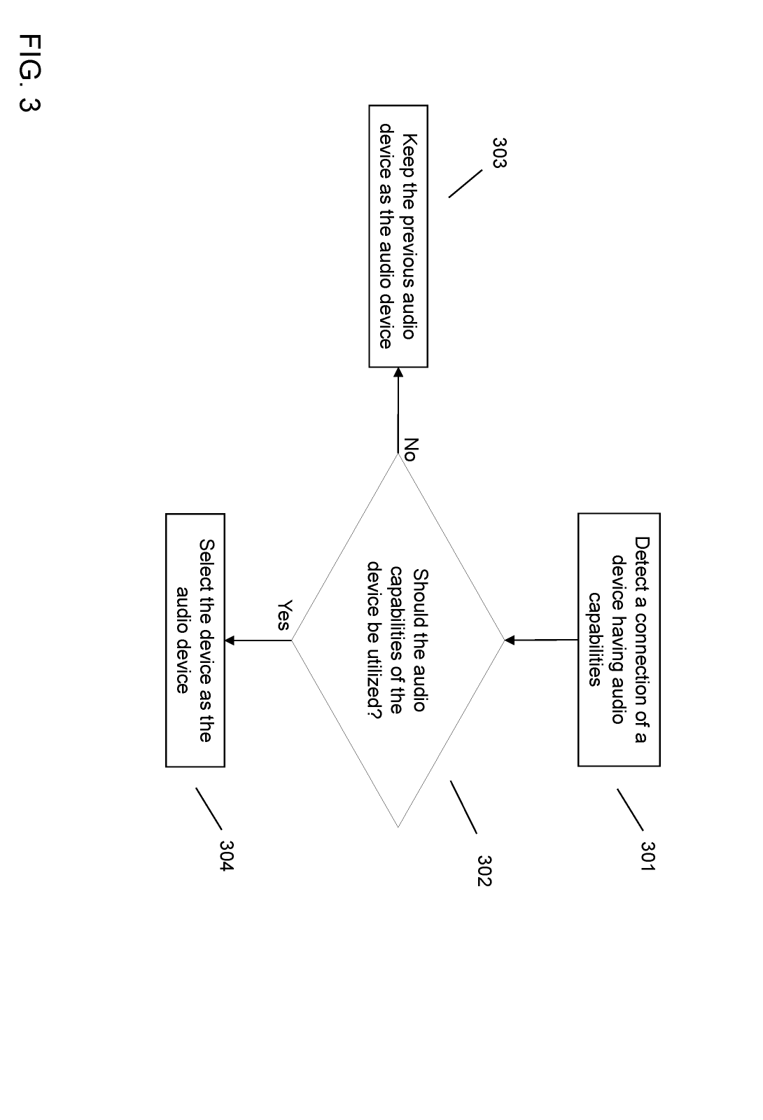

FIG. 3 illustrates an example method for selecting an audio output device to use for audio output of a computing system based upon determining whether the audio capabilities of a device should be utilized. The method may be implemented on a system which includes a processor, memory device, output devices (e.g., display device, printer, etc.), input devices (e.g., keyboard, touch screen, mouse, microphones, sensors, biometric scanners, etc.), image capture devices, and/or other components, for example, those discussed in connection with FIGS. 1 and/or 2. While the system may include known hardware and software components and/or hardware and software components developed in the future, the system itself is specifically programmed to perform the functions as described herein to select an audio output device for audio output for a computing system. Additionally, the audio configuration system includes modules and features that are unique to the described system.

The audio configuration system may be activated in order to select an audio output device to be used for audio output for a computing system. Thus, the audio configuration system may be activated upon the detection of a connection of a device having audio capabilities to the computing system. Alternatively, the audio configuration system may be a background application or program that runs whenever the computing system is active. The audio configuration system can then monitor for the connection of devices having audio capabilities and perform the described steps. Upon activation of the audio configuration system, the system determines which audio output device should be utilized for the audio output of the computing system, which may include determining if the audio output should be switched to the newly connected device or whether it should remain with a previously utilized audio output device.

Activation of the audio configuration system may be a manual activation of the audio configuration system and/or an automatic activation of the audio configuration system. Manual activation of the system may include a user opening an application associated with the audio configuration system, the user accessing the computing system associated with the audio configuration system, and/or the user otherwise providing input to the audio configuration system. The automatic activation of the audio configuration system may be based upon the detection of a trigger event indicating that the system should be activated. Example trigger events include the detection of a connection of a device having audio capabilities to the computing system, a user accessing an application that interfaces with the audio configuration system, activation of software or an application utilizing the audio configuration system, and/or the like.

The audio configuration system may be made of multiple systems or modules that communicate together to make up the audio configuration system or may be a single system. The audio configuration system may be a standalone system, may be accessible through other computing systems, and/or a combination thereof. For example, the audio configuration system may be a standalone system that can be accessed by a user and/or may be or provide an application that is accessible by a user on another computing system. The audio configuration system may be accessible using any type of computing system, for example, personal computer, laptop computer, smartphone, tablet, smartwatch, head-mounted display, smart television or other smart appliance, augmented reality device, virtual reality device, and/or the like.

Thus, the audio configuration system may be accessible locally using a computing system where the audio configuration system is installed and/or may be accessible remotely through another computing system. For example, the audio configuration system may be accessed by a user using a device that communicates with the audio configuration system to select an audio output device for audio output of a computing system, to determine whether the audio output of a computing system should be transferred to a new audio output device, and/or the like. However, the audio configuration system may be located and operate on a different information handling device to perform the described steps. In other words, the user may access a device housing the audio configuration system or may access a device that communicates with a device housing the audio configuration system.

The audio configuration system may have an associated graphical user interface. The graphical user interface may be provided on a display or monitor, which may or may not be associated with the audio configuration system. In other words, the audio configuration system may have a dedicated display or monitor or may be accessible using any display or monitor. In either case, the audio configuration system may provide instructions to generate and display the graphical user interface on the display device being used to access the audio configuration system. The graphical user interface may also be updated and managed based upon instructions provided by the audio configuration system. In other words, the audio configuration system generates and transmits instructions to create and update the graphical user interface.

The graphical user interface may include a plurality of tabs, windows, and/or unique interfaces. The graphical user interface may include graphical user interface icons or elements. Graphical user interface icons or elements may include static non-selectable elements (e.g., headers, footers, logos, global information areas, graphics, etc.), dynamic non-selectable elements (e.g., local information areas applying to a specific element, dynamic graphics, information areas that update based upon the information provided therein, indicators, statistics displays, etc.), static selectable elements (e.g., radio buttons, menu icons, selectable indicators, etc.), dynamic selectable elements (e.g., form field input areas, pull-down menus, pop-up windows, etc.), and/or any other elements that may be found in a graphical user interface.

The graphical user interface may allow a user to provide input identifying information to be used by the audio configuration system. For example, the audio configuration system may utilize user profiles, device profiles, historical information, and/or the like, to determine whether audio output of a computing system should be transferred to a different audio output device, to select an audio output device for audio output of the computing system, and/or the like. The graphical user interface may allow for creation of or access to these profiles, historical information, and/or the like, by allowing a user to input information regarding user preferences, device preferences, location or workspace preferences, and/or the like. As will be discussed in more detail, the use of user provided information is not the only way that the profile and/or historical information can be created. The audio configuration system can then utilize these inputs, whether provided directly by the user or identified using a different technique, to create the profile(s), store the historical information, and/or the like.

A user could also use the graphical user interface to adjust information within the profile(s), historical information, and/or the like. Additionally, or alternatively, the user can input a location of information related to one or more of the profiles, historical information, and/or the like, provide a file corresponding to information related to the information, and/or the like, within the graphical user interface. Input may be provided by the user using any type of input modality, including, but not limited to, mechanical input (e.g., keyboard input, mouse input, etc.), touch input, audible or voice input, gesture input, haptic input, thought input, gaze input, electromyography input, virtual or augmented reality input, and/or the like.

The graphical user interface may also provide displays that display information of the profiles, and/or the like. It should be noted that the information to be used by the audio configuration system and information provided by the audio configuration system can be different for different applications, different computing systems, different users, and/or the like. Thus, the information corresponding to input or output of the audio configuration system are not always the same. However, the audio configuration system may have default or system-wide settings that are the same across different users, systems, applications, and/or the like, until the information is adjusted or otherwise changed.

It should be noted that different users may configure the graphical user interface per their preferences. Thus, the graphical user interface layout and configuration may be different between users. How much a user can configure the layout may be restricted or set by a system administrator and/or the like. Additionally, different users or different user roles may have different levels of access, which may also change how and what information is displayed. Thus, different graphical user interfaces may be displayed by the system.

The audio configuration system may utilize one or more artificial intelligence models in selecting an audio output device for a computing system. Artificial intelligence models may also be used for steps within a step. For example, a model could be utilized to identify information that is utilized to determine factors that influence a determination regarding whether the audio output of the computing system should be transferred, identify potential audio output devices to select an audio output device, and/or the like.

For ease of readability, the majority of the description will refer to a single artificial intelligence model. However, it should be noted that an ensemble of artificial intelligence models or multiple artificial intelligence models may be utilized. Additionally, the term artificial intelligence model within this application encompasses neural networks, machine-learning models, deep learning models, artificial intelligence models or systems, and/or any other type of computer learning algorithm or artificial intelligence model that may be currently utilized or created in the future.

The artificial intelligence model may be a pre-trained model (e.g., a general model, such as a general classification model) that is fine-tuned for the audio configuration system, or the artificial intelligence model may be a model that is created and trained from scratch. Since the audio configuration system is used in conjunction with selecting an audio output device for audio output, some models that may be utilized by the system are image analysis models, text analysis models, audio analysis models, analysis models, similarity identification models, language models, large language models, entity identification models, input analysis models, filtering models, classification models, and/or the like. The model may be trained using one or more training datasets.

Additionally, as the model is deployed, it may receive feedback to become more accurate over time. Alternatively, or additionally, the model may utilize inputs provided to the model to learn continually, thereby using the inputs to make subsequent predictions or using the inputs within the subsequent predictions. The feedback or inputs may be automatically ingested by the model as it is deployed. For example, as the model is used to perform the described method, if a user modifies predictions that were made by the model, provides feedback regarding a prediction, or otherwise provides some indication that the predictions or selections made by the model may be incorrect, the model may ingest this feedback to refine the model.

On the other hand, as the model makes predictions in connection with performing the described steps, and no changes are made to the resulting prediction, the model may utilize this as feedback to further refine the model. This may be referred to as reinforcement training where a prediction that was made by the model is reinforced as the correct prediction. Training the model may be performed in one of any number of ways including, but not limited to, supervised learning, unsupervised learning, semi-supervised learning, training/validation/testing learning, active learning, transfer learning, weak supervision, data augmentation, weakly supervised learning, and/or the like. Accordingly, the training dataset may include annotated data, unannotated data, and/or the like, or a combination thereof.

Whether the model automatically ingests feedback during deployment or not may be determined by a user, author, and/or entity that has deployed the model. Automatic learning by the model may be useful in some applications, but may be detrimental in other applications. Accordingly, a user may make a determination regarding the trainability of the model during deployment. Regardless of whether the model can be retrained during deployment or is only retrained upon instruction by a user, the feedback or inputs could be stored within a data store and utilized at a later time to train or retrain the model. For example, a user could use the feedback to update a training dataset to train or retrain the model. The feedback or inputs could also be stored within the data store and then be used by the model for updated training. This may be done, for example, in an unsupervised learning session that allows the model to learn patterns and information regarding the training dataset without the need for human supervision, thereby providing at least a partially automated technique for the model to become updated. However, the model may or may not perform this retraining without a human providing input to the model to perform the retraining. In other words, retraining of the model may be based upon how the model is programmed and whether the model is updated while it is deployed or is only updated during a training mode may be based upon that programming.

As previously mentioned, an ensemble of models or multiple models may also be utilized. Some example models that may be utilized are variational autoencoders, generative adversarial networks, recurrent neural networks, convolutional neural networks, deep neural networks, autoencoders, random forest, decision tree, gradient boosting machine, extreme gradient boosting, multimodal machine learning, unsupervised learning models, deep learning models, transformer models, inference models, and/or the like, including models that may be developed in the future. The chosen model structure may be dependent on the particular task that will be performed with that model. Additionally, the feature sets, vectors, layers, outputs, and/or other characteristics of the model may be chosen by a user based upon the application.

The audio configuration system may include different components for carrying out different functions of the system, including different steps to be performed. These components may be hardware components or software components. Some hardware devices or components that may be utilized by the audio configuration system include input devices that may be utilized to receive input from the user, for example, mechanical input modalities (e.g., keyboard, mouse, etc.), touch input devices, gesture input devices, electromyography input devices, audio input devices, and/or the like. Other hardware components may be utilized to provide output from the audio configuration system. For example, the audio configuration system may include speakers, displays or monitors, haptic output devices, audio output devices, and/or the like.

Other hardware components may be included to capture images, for example, an image capture device, screen capture devices, and/or the like. Other hardware components may include data storage devices, including on devices of the user (e.g., mobile device, personal computer, laptop, tablet, smart watch, etc.), devices or components of the audio configuration system, and/or the like. The audio configuration system may also interface with hardware components of a device. For example, instead of the audio configuration system including a display, the audio configuration system may provide instructions to display content on a display component of a user device that is employing or communicating with the audio configuration system.

One software component may include a data storage location or data repository that stores information related to user profiles, devices, workspaces, and/or the like. Information may be stored in the data storage location using any data storage technique. Additionally, the system can access the information stored within the data storage location using any type of querying technique, filtering technique, and/or the like. The information contained within the data storage location may also be organized, for example, grouped by device, grouped by user, grouped by workspace, grouped by computing system, and/or the like. The information within the data repository may be indexed for efficient information retrieval. The information may be stored within the data repository may be indexed based upon an identifier assigned to a device, an identifier assigned to a computing system, an identifier assigned to a user, an identifier assigned to a workspace, and/or the like. The information stored within the data repository may be indexed or grouped based upon multiple identifiers or other characteristics. Thus, the data repository can allow for filtering and sorting.

Another software component includes one or more profiles that store information related to devices, users, computing systems, workspaces, and/or the like. The profiles may include preferences or settings corresponding to the profile. For example, a profile corresponding to a user may identify factors or characteristics that can be used to determine if the audio output of the computing system should utilize the audio capabilities of the device, may identify user preferences related to a particular device or device type, and/or the like. As another example, a profile corresponding to a particular computing system can include information related to how specific devices should be treated, information related to how devices at particular workspaces or locations should be treated, and/or the like. Information within a profile may be identified through manual input, or may be identified by the audio configuration system as the system is utilized and inputs are provided to the system. Thus, the audio configuration system can monitor inputs provided at both a device and also at external components. Once inputs have been provided (e.g., manual input, audible input, gesture input, etc.), the audio configuration system can store this information or settings within a profile.

The provided inputs may also be inputs that are inferred from other inputs. In other words, the audio configuration system can monitor a user, and/or the like, to determine if audio output should be transferred to a different device. For example, the audio configuration system may monitor user inputs to detect when the user makes a manual change back to a particular setting or selects a different audio output device. From this input, the system can determine different factors that could influence the decision of the user regarding the selected audio output device. These factors can then be stored and utilized for subsequent determinations and audio device selections.

As another example, the audio configuration system may monitor user movements, facial expressions, gestures, audible input, and/or other inputs, to determine that the user does or does not want the audio output device to be changed. For example, a user may look annoyed or flustered when the audio output is changed to a new device and the system may infer that the user did not want this change. Thus, the audio configuration system may monitor a user for inputs other than those inputs provided directly to the audio configuration system. Additionally, the inferred inputs do not have to be provided by a user. Thus, the audio configuration system may also monitor other components or devices that may provide inputs that would indicate that the audio configuration system should perform some function. In inferring or correlating inputs, the system may utilize one or more techniques that allows for the inference or identification of information including, but not limited to, rules engines, artificial intelligence models, correlation techniques, and/or the like. These techniques may take the identified information as input, analyze that input based upon the technique programming, and provide an output related to the desired information. This information may then also be placed within a profile for later access.

Any of the mentioned profiles, or other profiles, may include additional information that may be useful for the audio configuration system and may be entered by a user, may be default values, may be learned by the system over time, and/or the like. Thus, profiles can be populated with information manually by a user, entities or companies, and/or the like, or can be populated over time as the system learns more about the user, components, images, entities or companies, and/or the like. For example, a user may manually provide input to a user profile and the system can learn preferences about the user over time and populate the user profile with this learned information.

Learned information may be information learned based upon direct inputs, for example, a user may be presented with a pop-up window in response to a trigger and provide input to the pop-up window. This input can be then populated into a profile. Learned information may also be information learned based upon indirect inputs, for example, a user may provide inputs (e.g., audible inputs, visual inputs, gesture inputs, etc.) that indicate that the user would like to switch an audio output device, that a user is frustrated with an automatic selection of an audio output device, and/or the like. The system can then aggregate this information to learn information over time. With respect to the described audio configuration system, the learned information may include historical information, determinations of when the audio output device should be transferred, selections of audio output devices, and/or the like.

At 301, the audio configuration device may detect a connection of a device having audio capabilities to a computing system. A computing system will be referred to herein for ease of readability. However, it should be noted that the computing system may be any type of system or device to which other components or devices should be connected. For example, the computing system may be a portable information handling device, for example, a laptop, a tablet, a smart phone, and/or the like. The computing system may also be a more stationary computing system, for example, desktop computers, servers, televisions, and/or any other devices to which other components or devices can be connected.

For example, the described system could be utilized on devices that can be accessed from different locations even if the system itself is not moved. For example, a person could VPN into a system utilizing another device. The system being accessed through the VPN (referred to as the remote device for ease of readability) could have one audio output device setting, whereas the device being utilized to VPN into the system (referred to as the local device for ease of readability) could have a different audio output device. Depending on the connection, audio could be output at the remote device and unheard by the user. Thus, the described system could be utilized in this situation to determine that the selected audio output device should be an audio output device on the local device.

The device may be an external device, meaning the device is external to the computing system. The device may have audio capabilities built into the device, for example, a display with internal or external speakers and/or microphone, a docking station with connected speakers, a docking station with connected microphone, a camera with speaker and/or microphone, and/or the like. Alternatively, or additionally, the device may be a device that only provides for audio input/output capabilities, for example, an external speaker, headphones or earbuds, microphone, headphones or earbuds with microphone, and/or the like. Thus, the device may only provide audio capabilities or may have capabilities additional to the audio capabilities. While a speaker or audio output device will be discussed as the primary example, it should be noted that this is not limiting, as any type of audio output device or audio input device can be used with the described audio configuration system.

In the case that the device has no audio capabilities or the audio capabilities could not be used by the computing system for some reason, the audio configuration system may take no action with respect to the device and/or the audio output of the computing system in view of the connection of the device. Thus, the system may not only detect that a device having audio capabilities has been detected, but the system may also detect that a device having audio capabilities that are usable by the computing system has been detected. In other words, the audio configuration system may detect that a device having usable audio capabilities has been detected.

In addition to detecting that a device having audio capabilities has been connected, the audio configuration system may detect a type of the device. The type of the device may refer to a category of device, for example, external speaker, display device, headphones, earbuds, microphone, laptop computer, and/or the like. Alternatively, or additionally, the type of device may refer to the audio capabilities of a device, for example, audio input device, audio output device, combination audio input/output device, and/or the like. Alternatively, or additionally, the type of device may refer to the type of sounds that are produced or captured, for example, personal audio device where the audible input/output is confined to a single person (e.g., headphones, personal microphone, earbuds, a combination thereof, etc.), where the audible input/output is produced such that multiple people could hear it simultaneously (e.g., speaker, conference microphone, loudspeaker, table microphone, external device speaker, external device microphone a combination thereof, etc.), and/or the like.

At 302, the audio configuration system may determine if the audio capabilities of the newly connected device should be utilized. output of the computing system should be transferred to another device based upon the connection of the device to the computing system. In other words, the audio configuration system may determine, responsive to the detecting of 301, whether either the audio output and/or audio input of the computing system should utilize the audio capabilities of the device. Different techniques may be utilized to make this determination. While the techniques may be described alone, it should be noted that a combination of techniques can be utilized. It should be noted that while transferring or switching the audio input/output of the computing system will be discussed, this also includes using the audio capabilities of the device in conjunction with previously available audio capabilities. Thus, transferring and/or switching is not intended to exclude using more than one audio device at a time.

One technique for determining whether the audio output of the computing system should be transferred or switched to the device is to utilize historical audio output settings used with the device. As a device is connected or disconnected from a computing system, a user may make selections for the audio output device to be utilized. Additionally, the user or system may make changes regarding characteristics of the sound (e.g., volume, frequency adjustments, audio output direction, audio input sensitivity, etc.). This information can be utilized to determine whether the audio output should utilize the audio capabilities of the device. For example, if the user has historically switched the audio output to the device when it is connected, the system may make this same change upon detecting that device. As another example, if the user has not historically switched the audio output to the device when it is connected, the system may not transfer the audio output of the computing system to the device upon detecting the connection of that device. Thus, the system may select the audio output device based upon the historical audio output settings used with that device, meaning the audio output settings that were used when the device has been connected previously to the computing system.

In another technique, a ruleset or rules engine may be employed to make the determination regarding whether an audio output of the computing system should be transferred. For example, the ruleset or rules engine may identify specific characteristics or attributes of a user, user location, device, computing system, and/or the like, which may drive whether the audio output of the computing system should be transferred. As an example, the ruleset may indicate that if the user is using a particular computing system and a particular device having audio capabilities is connected, the audio configuration system should perform a particular action.

Additionally, or alternatively, an artificial intelligence model could be utilized in determining whether the audio output of the computing system should utilize the audio capabilities of the device. There are many different factors that may dictate whether a user would want the audio output of a computing system to be transferred to a different audio output device, for example, a location of the computing system, a device having audio capabilities that is detected, a time of day, a day of the week, how long the user might be within a particular location, and/or the like. The artificial intelligence model could learn these different factors and the user preferences correlated with these factors, and then be utilized to make the determination regarding whether the audio output of the computing system should be transferred. For example, the artificial intelligence model may learn that on Mondays when the user is utilizing a particular laptop computer at a workspace and connects the laptop to a docking station, the user wants the audio output to be transferred to a different audio output device. On the other hand, on Tuesdays with the same other factors, the user may not want the audio output be transferred.

As another example, the artificial intelligence model may learn that a user does not want the audio output transferred if the user will be at a location for less than a predetermined threshold period of time, but the user does want the audio output transferred if the user will be at the location for more than the predetermined threshold of time. The artificial intelligence model can then identify factors that provide indications regarding whether the user will be at the location for less than or greater than the predetermined threshold of time.

Another technique includes initially utilizing the connected device for audio output (or audio input). A test tone is then output through the audio output, which would be audible from the connected device assuming that the audio output of the connected device is functioning and audible. The audio configuration system may then determine whether the test tone is audible to an audio input device of the computing system. Whether the test tone is audible to an audio input component would indicate whether the audio output of the connected device is functioning and/or audible. For example, the device may have audio output capabilities, but the audio output component of the device may be disabled, non-functioning, undetectable, broken, and/or the like. In this case, the test tone would not be audible to an audio input component because the test tone is not actually audible from the audio output component of the device. Thus, this provides an indication of whether the audio output should utilize the audio capabilities of the device.

Additionally, in some cases it may be necessary to use more than one audio input device to hear the test tone. Acoustic echo cancellation (AEC) technology, if utilized within the system, may attempt to remove speaker output from sound input to an input device. If there is such an AEC system in place between a particular combination of audio output and audio input device, then the test tone may not be detected even though the test tone is audible. Thus, more than one audio input device may be utilized to see if the test tone is audible at any of the audio input devices. Additionally, technology, for example, an AI model, signal processing techniques, and/or the like, could be utilized to detect the use of AEC technology. The AI model could detect artefacts or signals that may be left by the AEC technology to determine that an AEC system was utilized, thereby determining that the test tone was audible.

If the test tone is audible to an audio input component of the computing system, the system may then determine that the device can be maintained as an audio output device. On the other hand, if the test tone is not audible at the audio input component of the computing system, the system may then determine that the device should not be used as an audio output device. Accordingly, the system may utilize an audio output device that was utilized before the connection of the device as the audio output device. In other words, the audio configuration system will transfer the audio output back to a previously utilized audio output device. In some cases, the audio configuration system may detect that an audio input device is muted, which would result in the test tone being inaudible even if produced by the audio output device. Thus, the system may unmute the audio input device for a duration of the test tone in order to ensure that the test tone would be audible if produced.

It should be noted that a similar technique can be utilized for an audio input device. In this case, a test tone would be output through the audio output of the computing system (or audio output device being utilized by the computing system). The audio configuration system may then determine whether the test tone is audible to an audio input component of the connected device. If the test tone is not audible to the audio input component of the connected device, the audio configuration system may determine that the audio input component of the connected device is disabled, broken, or otherwise not functioning and, therefore, the audio input of the computing system should not be transferred to the device.

Another technique for determining whether the audio output or audio input should utilize the audio capabilities of the device is to display a prompt to the user of the computing system requesting the user provide input regarding the audio device to be selected. The prompt or notification may be presented to the user indicating that a desired configuration of the audio of the computing system could be changed with the connection of the device. The prompt may then request the user provide input indicating to which device the audio should be transferred, if at all. This prompt may be displayed if the system identifies an ambiguity during the determination. In other words, if the system is unable to automatically identify whether the audio capabilities of the device should be utilized as a primary audio source, as a default audio source, or as an audio source for a specific application or sound input/output, then the system may present the prompt. However, the prompt could be provided even if an ambiguity is not identified.

The determining may also include identifying that the audio capabilities of the device are not connected to an audio output component. In the case that the device has audio capabilities that require an additional component that is external to the device and that is connected to a connector of the device the determining may be based upon identifying a state of that connection. As a non-limiting example, a monitor may have external speakers that are connected to the system through a jack or connection on the monitor. The system could include jack sensing which can detect if a connector is plugged into the connector. Jack sensing measures the impedance and other characteristics of the plugged in component. Thus, jack sensing can be utilized to detect if no component is plugged into the monitor. In this case, the audio configuration would determine that, while the device has audio capabilities, it does not have the capability to actually output or input audio due to the fact that no component is plugged into the connector. This is merely an example, as other techniques for detecting plugged-in components can be utilized. Other techniques for determining whether the audio should utilize the audio capabilities of the device are contemplated and possible, and the described techniques are merely examples and are not intended to be limiting. Additionally, a combination of techniques may be utilized.

The technique that is selected for performing the determination whether the audio output of the computing system should be transferred to the connected device may be based upon the type of the device. For example, if the device is a personal audio device, output of a test tone even if the audio output can be switched to the audio device may not be audible by a microphone. Thus, using this technique for determining whether the audio output of the computing system should be transferred would not result in an audible audio output even if the user wants the personal audio device as the audio output device. In this case, a different technique for determining whether the audio output of the computing system should be transferred would be more appropriate.

Other factors may be taken into account when determining what technique to utilize to determine if the audio output should be transferred. Example other factors may include, but are not limited to, capabilities of the computing system, a location of the computing system, an environment of the computing system, a location of the device, and/or the like. As an example, if the computing system does not have a visible display, for example, a laptop device where the display is covered, then presenting a visual notification or request to the user will not be an effective technique. An environment of the computing system may refer to the objects and/or people that are within a predetermined proximity to the computing system or a potential audio output device and a context of the space around the computing system or a potential audio output device (e.g., a noise level of the space, a brightness of the space, a movement of the space, etc.). Thus, as another example, if the computing system is in an environment with a large number of people within close proximity to the computing system and the noise level is very low, producing a test tone may not be the best technique because it would disturb other people. As another example, if the computing system is in an environment with a large number of people within close proximity and the space is moving (e.g., in a car, on a bus, on a boat, etc.), producing a test tone may not be the best technique because it would not be heard by a microphone.

If, at 302, the audio configuration system determines that the audio capabilities of the device should not be utilized, the system may keep the previous audio output device as the audio output device at 303. In other words, if the audio capabilities of the device should not be utilized (e.g., as a default audio device, as a primary audio device, as an audio device for a particular application, as an audio device for a particular sound, etc.), the system may select a previously used audio output device as the audio output device for the computing system, for example, as the default audio device, as a primary audio device, as an audio device for a particular application, as an audio device for a particular sound, and/or the like. In other words, if the audio capabilities of the device should not be utilized, the selecting may include not utilizing the device as a default audio output device.

The previous audio output device may be the audio output device from which the audio output was going to be switched. In other words, the previous audio output device may be the audio output device that was being utilized immediately preceding the connection of the device to the computing system. Alternatively, the previous audio output device may be a different audio output device that was available as an audio output device before the device was connected. If, on the other hand, the audio configuration system determines that the audio output of the computing system should utilize the audio capabilities of the device at 302, the system may select the device as the audio device at 304. This means that at least some of the audio output and/or input of the computing system will now be directed to the newly connected device. This may mean that the audio output and/or input of the newly connected device is used in conjunction with other audio output and/or input devices accessible to the computing system, that the audio capabilities of the device will only be used, and/or the like.

In addition to determining which audio output device should be utilized, the system may also determine settings for the audio output device that is selected. Thus, selecting the audio output device may also include adjusting a setting of the audio output device. In other words, the system may adjust a setting of the audio output of the computing system based upon the audio output device that is selected. If the audio settings (e.g., volume, audio characteristics, microphone sensitivity, etc.), were modified in order to perform the determination and a previous device is selected as the audio device, then the settings may be reverted back to previous settings. Additionally, upon the connection of a new device, the audio settings may need to be modified in order to utilize the new audio device. Accordingly, the system may adjust the audio settings based upon the use of this new device. In order to determine the correct audio settings, the system may utilize the historical information, information contained within a profile, an artificial intelligence model, a rules engine, and/or any other number of techniques, or a combination thereof.

As an overall, non-limiting example, a user may have a laptop computer that is utilized at home and at work. When the user takes the laptop to work and sets it up at a workspace, the workspace may include two monitors, each having an external speaker. Before being connected to the workspace monitors, the laptop may have an integral speaker that is being utilized for audio output. Upon connection to the monitors, the system may detect that two new potential audio output devices have been connected. The system may utilize one or more of the described techniques to determine that the audio output of the laptop should be transferred to one of the monitors. The system then transfers the audio output of the laptop to the selected audio output device.

It will be readily understood that the components of the embodiments, as generally described and illustrated in the figures herein, may be arranged and designed in a wide variety of different configurations in addition to the described example embodiments. Thus, the more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As will be appreciated by one skilled in the art, various aspects may be embodied as a system, method, or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices, and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, the method comprising:
detecting, using an audio configuration system, a connection of a device having audio capabilities to a computing system;
determining, using the audio configuration system and responsive to the detecting, whether at least one of: an audio output and an audio input of the computing system should utilize the audio capabilities of the device; and
selecting, based upon the determining, an audio device for at least one of: the audio output and the audio input.

2. The method of claim 1, wherein the determining comprises outputting a test tone utilizing the audio capabilities of the device; and
determining whether the test tone is audible to an audio input device of the computing system.

3. The method of claim 2, wherein the selecting comprises, responsive to determining the test tone is audible, selecting the device as a default audio output device.

4. The method of claim 2, wherein the selecting comprises, responsive to determining the test tone is not audible, not utilizing the device as a default audio output device.

5. The method of claim 2, comprising detecting the audio input device is muted; and
unmuting the audio input device for a duration of the test tone.

6. The method of claim 1, wherein the determining comprises accessing historical audio settings used with the device; and
wherein the selecting comprises selecting the audio device based upon the historical audio settings used with the device.

7. The method of claim 1, wherein the detecting comprises detecting a type of the device and wherein a technique for performing the determining is based upon the type of the device.

8. The method of claim 1, wherein the determining comprises identifying that the audio capabilities of the device are not connected to an audio output component.

9. The method of claim 1, wherein the determining comprises, responsive to identifying an ambiguity during the determining, displaying a prompt to a user of the computing system requesting input regarding the audio device to be selected.

10. The method of claim 1, wherein the audio device comprises one of: the device and an audio device utilized before the connection of the device.

11. A system, the system comprising:
a processor;
a memory device that stores instructions that, when executed by the processor, causes the system to:
detect, using an audio configuration system, a connection of a device having audio capabilities to a computing system;
determine, using the audio configuration system and responsive to the detecting, whether at least one of: an audio output and an audio input of the computing system should utilize the audio capabilities of the device; and
select, based upon the determining, an audio device for at least one of: the audio output and the audio input.

12. The system of claim 11, wherein the determining comprises transferring the audio output to the device;
outputting a test tone via the audio output; and
determining whether the test tone is audible to an audio input device of the computing system.

13. The system of claim 12, wherein the selecting comprises, responsive to determining the test tone is audible, maintaining the device as the audio output device.

14. The system of claim 12, wherein the selecting comprises, responsive to determining the test tone is not audible, utilizing an audio output device utilized before the connection of the device as the audio output device.

15. The system of claim 12, comprising detecting the audio input device is muted; and
unmuting the audio input device for a duration of the test tone.

16. The system of claim 11, wherein the determining comprises accessing historical audio settings used with the device; and
wherein the selecting comprises selecting the audio device based upon the historical audio settings used with the device.

17. The system of claim 11, wherein the detecting comprises detecting a type of the device and wherein a technique for performing the determining is based upon the type of the device.

18. The system of claim 11, wherein the determining comprises identifying that the audio capabilities of the device are not connected to an audio output component.

19. The system of claim 11, wherein the determining comprises displaying a prompt to a user of the computing system requesting input regarding the audio device to be selected.

20. A product, the product comprising:
a computer-readable storage device that stores executable code that, when executed by a processor, causes the product to:
detect, using an audio configuration system, a connection of a device having audio capabilities to a computing system;
determine, using the audio configuration system and responsive to the detecting, whether at least one of: an audio output and an audio input of the computing system should utilize the audio capabilities of the device; and
select, based upon the determining, an audio device for at least one of: the audio output and the audio input.
